(19) United States
(12) Patent Application Publication
(10) Pub. No.: US 2023/0342690 A1
(43) Pub. Date: Oct. 26, 2023

(54) PRESENTATION OF AUTOMATED PETROTECHNICAL DATA MANAGEMENT IN A CLOUD COMPUTING ENVIRONMENT

(71) Applicant: SCHLUMBERGER TECHNOLOGY CORPORATION, Sugar Land, TX (US)

(72) Inventors: Jamie CRUISE, Surrey (GB); Andrew MACGREGOR, Redhill (GB); Fernando Nahu CANTERA RUBIO, Houston, TX (US); Anuj GOEL, London (GB)

(21) Appl. No.: 18/245,846

(22) PCT Filed: Sep. 16, 2021
(86) PCT No.: PCT/US2021/071477

§ 371 Date: Mar. 17, 2023

Related U.S. Application Data
(60) Provisional application No. 62/706,909, filed on Sep. 17, 2020.

(51) Int. Cl. G06Q 10/0631

(52) U.S. Cl. CPC G06Q 10/06316

(57) ABSTRACT

Methods, computing systems, and non-transitory computer-readable media are disclosed for automating and tracking loading and management of data into a data ecosystem. Data is ingested into the data ecosystem. The ingested data is standardized to generate standardized data and metadata for storage and display. The standardized data is quality controlled to produce quality controlled standardized data. The quality controlled standardized data is approved. Progress of the ingesting, the standardizing, the quality controlling, and the approving is displayed on a Kanban board.

This application claims the benefit of U.S. Provisional Patent Application No. 62/706,909, filed in the U.S. Patent and Trademark Office on Sep. 17, 2020, the content of which is hereby incorporated by reference herein in its entirety.

### BACKGROUND

Petrotechnical data may be loaded into a workflow or application to process the data as part of a simulation and/or any other variety of applications relating to oil/gas exploration, analysis, recovery, etc. Loading and managing oil and gas petrotechnical data at a relatively large scale (e.g., in a cloud computing environment) with an immutable data ecosystem may involve extensive and time-consuming manual quality control checks. For example, job failures may occur at any time during data preparation for approval and release to users. Data managers must therefore manually address such failures and intervene at any stage of the job to take appropriate action.

### SUMMARY

Embodiments of the disclosure may provide a uniform method for automating and tracking loading and management of multiple types of data into a data ecosystem. According to the method, at least one computing device ingests data into the data ecosystem in response to receiving an instruction to ingest the data. The ingested data is then standardized to generate standardized data and metadata for storage and display. The standardized data is quality controlled to produce quality control standardized data. Then the quality control standardized data is approved. Progress of the ingesting, the standardizing, the quality controlling, and the approving are displayed in a Kanban board.

In an embodiment, the uniform method may include the data being ingested, standardized, quality controlled, and approved for multiple jobs. Data of each of the jobs is of a respective data type, and the respective data types of at least two of the jobs are not of a same data type.

In an embodiment, the uniform method includes standardizing the data according to a standard.

In an embodiment, the ingesting of the data, may include validating the data.

In an embodiment, the uniform method may include automatically passing successfully processed data that has been successfully ingested, successfully standardized, or successfully quality reviewed to a next process. When the data is successfully ingested, the next process is standardizing. When the data is successfully standardized, the next processes quality control. When the data is successfully quality controlled, the next process is approval.

In an embodiment, the uniform method may further include receiving approval of the data after a quality review of the data is completed, wherein the receiving the approval further includes attaching an approval tag to the approved data.

In an embodiment, the uniform method further includes receiving a selection of a card from among multiple cards displayed on the Kanban board, and displaying detail regarding a task represented by the card in response to the receiving of the selection.

Embodiments of the disclosure may also provide a computing system for automating and tracking loading and management of multiple types of data into a data ecosystem. The computing system includes a processor and a memory connected with the processor. The memory includes instructions for the computing system to perform a number of operations. According to the operations, data is ingested into a data ecosystem. The ingested data is then standardized to generate standardized data and metadata for storage and display. The standardized data is quality control to produce quality controlled standardized data. The quality controlled standardized data then is approved. Progress of the ingesting, the standardizing, the quality controlling, and the approving are displayed in a Kanban board.

In an embodiment of the computing system, the data being ingested, standardized, quality control, and approved is for multiple jobs. Data of each of the jobs is of a respective data type, and the respective datatypes of at least two of the jobs are not of a same data type.

In an embodiment of the computing system, the data is standardized according to only one standard.

In an embodiment of the computing system, the ingesting of the data further includes validating the data. The operations further include receiving a selection of one of a number of Kanban cards displayed on the Kanban board. In response to the receiving of the selection, detail of a task represented by the selected one of the Kanban cards is displayed.

In an embodiment of the computing system, the ingesting of the data further includes validating the data.

In an embodiment of the computing system, the operations further include automatically passing successfully processed data that has been successfully ingested, successfully standardized, or successfully quality reviewed, to a next process. When the data is successfully ingested, the next process is standardizing. When the data is successfully standardized, the next process is quality control. When the data is successfully quality controlled, the next process is approval.

In an embodiment of the computing system, the operations further include receiving approval of the data after a quality review of the data is completed, wherein the receiving the approval further includes attaching an approval tag to the approved data.

In an embodiment of the computing system, the operations further include receiving a selection of one of a number of cards displayed on the Kanban board, and displaying detail regarding a task represented by the selected one of the cards in response to the receiving of the selection.

Embodiments of the disclosure may provide a non-transitory machine-readable medium having instructions stored thereon to configure a computing device to perform operations. According to the operations, data is ingested into a data ecosystem. The ingested data is standardized to generate standardized data and metadata for storage and display. The standardized data is quality controlled to produce quality controlled standardized data. The quality controlled standardized data is approved. A Kanban board displays progress of the ingesting, the standardizing, the quality controlling, and the approving. The data being ingested, standardized, quality control, and approved is for multiple jobs. Data of each of the jobs is of a respective data type, and the respective data types of at least two of the jobs are not of the same data type.

In an embodiment of the non-transitory machine-readable medium, the data is standardized according to an Open Group Open Subsurface Data Universe (OSDU) standard.

In an embodiment of the non-transitory machine-readable medium, the ingesting of the data includes validating the data.

In an embodiment of the non-transitory machine-readable medium, the operations further include automatically passing successfully processed data that has been successfully ingested, successfully standardized, or successfully quality reviewed, to a next process. When the data is successfully ingested, the next process is standardizing. When the data is successfully standardized, the next process is quality control. When the data is successfully quality controlled, the next process is approval.

In an embodiment of the non-transitory machine-readable medium, the operations further include receiving approval of the data after a quality review of the data is completed, wherein the receiving of the approval further includes attaching an approval tag to the approved data.

In an embodiment of the non-transitory machine-readable medium, the operations further include receiving a selection of one of a number of cards displayed on the Kanban board, and displaying detail regarding a task represented by the selected one of the cards in response to the receiving of the selection.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates an example user interface of an empty Kanban board, according to an embodiment.

FIG. 3 illustrates a new submission dialogue screen that may be presented after a file is dragged and dropped to the Kanban board, according to an embodiment.

FIG. 4 illustrates a Process Control screen used in data loading, according to an embodiment.

FIG. 5 shows an example new submission dialogue with a selected frame of reference tab, according to an embodiment.

FIG. 6 shows an example new submission dialogue with a selected geolocation mapping tab, according to an embodiment.

FIG. 7 shows an example new submission dialogue with a selected geolocation mapping tab, according to an embodiment.

FIG. 8 shows a new Kanban card added to an ingest section of a Kanban board after completion of the new submission dialogue, according to an embodiment.

FIG. 9 shows an example job detail screen, which may be presented in response to selection of a Kanban card on a Kanban board while ingestion is being performed for a job represented by the Kanban card, according to an embodiment.

FIG. 10 shows a Kanban card in an approval section of the Kanban board while approval is pending.

FIG. 11 shows a list of data records along with a corresponding quality control score and a corresponding quality control status for each of the data records after the Kanban card of FIG. 10 is selected, according to an embodiment.

FIG. 12 illustrates an example a computing system, according to an embodiment.

### DETAILED DESCRIPTION

Loading and managing oil and gas petrotechnical data with an immutable data ecosystem may involve extensive and time-consuming manual quality control checks. The level of effort and time may be exponentially higher when working with larger data volumes (e.g., in a cloud computing environment). Accordingly, aspects of the present disclosure may facilitate and simplify the loading and/or management of oil and gas petrotechnical data to reduce an amount of time and effort to manually load and manage the data, while improving overall accuracy of the data that is loaded to an application/workflow.

In some embodiments, the loading process, in accordance with aspects of the present disclosure may be automated such that manual intervention to quality control the data is reduced. As described herein, an automated data loading may include:
Ingestion where the data is brought into the Data Ecoystem;
Standardization where metadata is generated and the data entity is standardized for storage and display;
Quality control where both automated data scoring and manual inspection of the data will take place;
Approval where business approval for use of the data by users is given according to company business processes.

In some embodiments, as data loading proceeds through the above-noted stages, data users (e.g., data managers) may track and manage each data loading job. Further, aspects of the present disclosure may permit data users able to intervene at each stage as needed to correct any problems. For example, aspects of the present disclosure may permit access to each stage of the loading job as the job progresses. Accordingly, a horizontal swim lane may be provided for each data loading job, with a status card for each of four stages. As one example, a data loading workflow may be illustrated as a Kanban board. In some embodiments, the Kanban board may be used to effectively manage multi-stage data loading workflow. The Kanban board may be used by any user (e.g., data managers, data scientists, petrotechnical users, etc.) loading data to an application (e.g., DELFI® (DELFI is a registered trademark of Schlumberger Technology Corporation of Sugar Land, Texas), and/or any other variety of application).

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

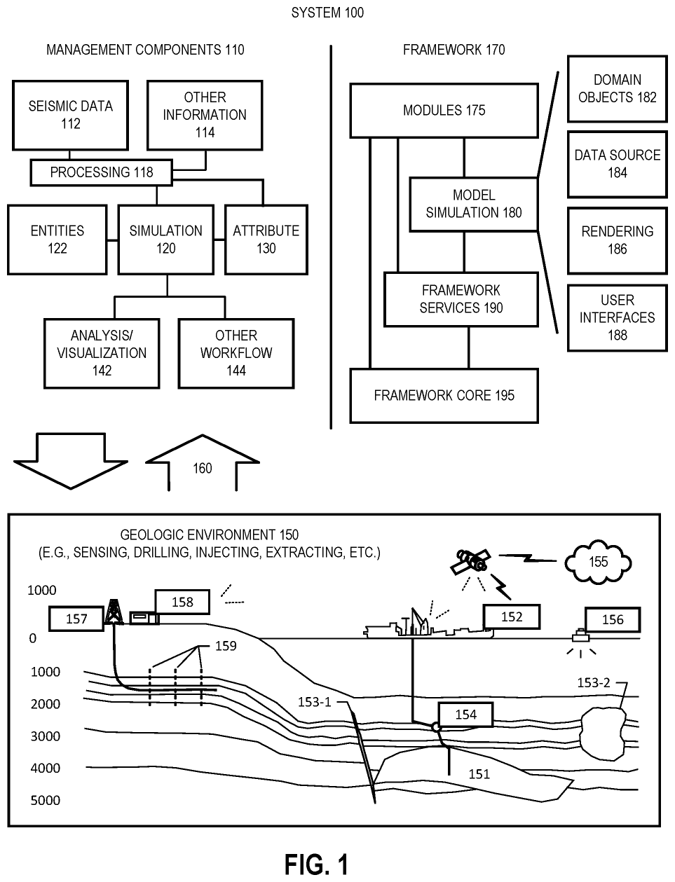

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT® .NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Texas), the INTERSECT™ reservoir simulator (Schlumberger Limited, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Texas) allows for integration of add-ons (or plug-ins) into a PETREL® framework workflow. The OCEAN® framework environment leverages .NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a workstep may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

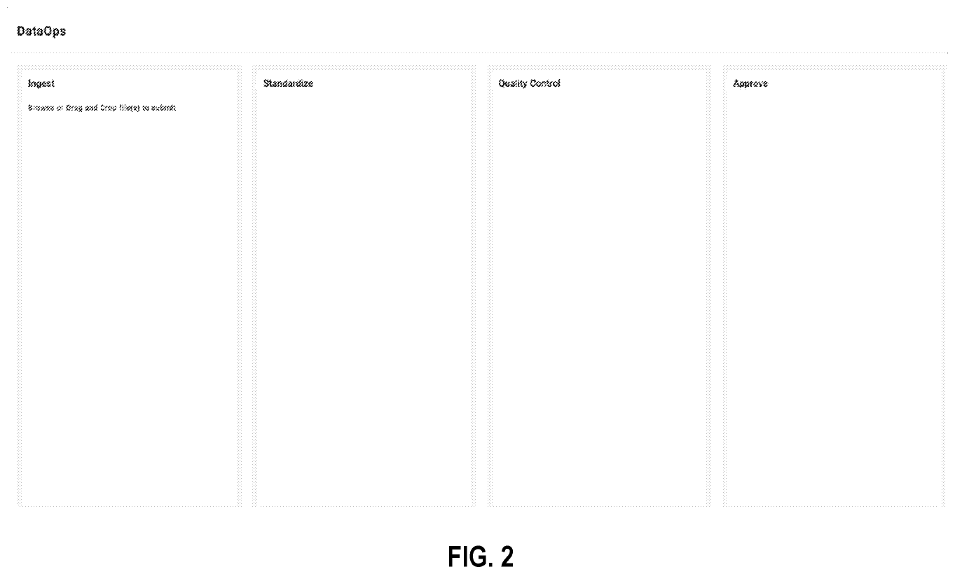

FIG. 2 illustrates an example user interface of a Kanban board in accordance with aspects of the present disclosure. As shown in FIG. 2, the Kanban board may initially be empty. That is, initially no data loading jobs may be executing. However, if data loading jobs were executing, each data loading job may be tracked horizontally across the Kanban board as a series of status or Kanban cards, with a job status for each stage being displayed on the card in a vertical column. In some embodiments, a user may select any card and may be presented with detailed information on the status of each file or dataset that was part of the loading job. In some situations, some files in the job may fail to load. In such a situation, the user will be able to “drill down” to understand the reason for the failure and to take a corrective action. The user may be presented with additional information to examine the data from the relevant viewer depending on data type. Further, the user may review/edit the metadata associated each data item.

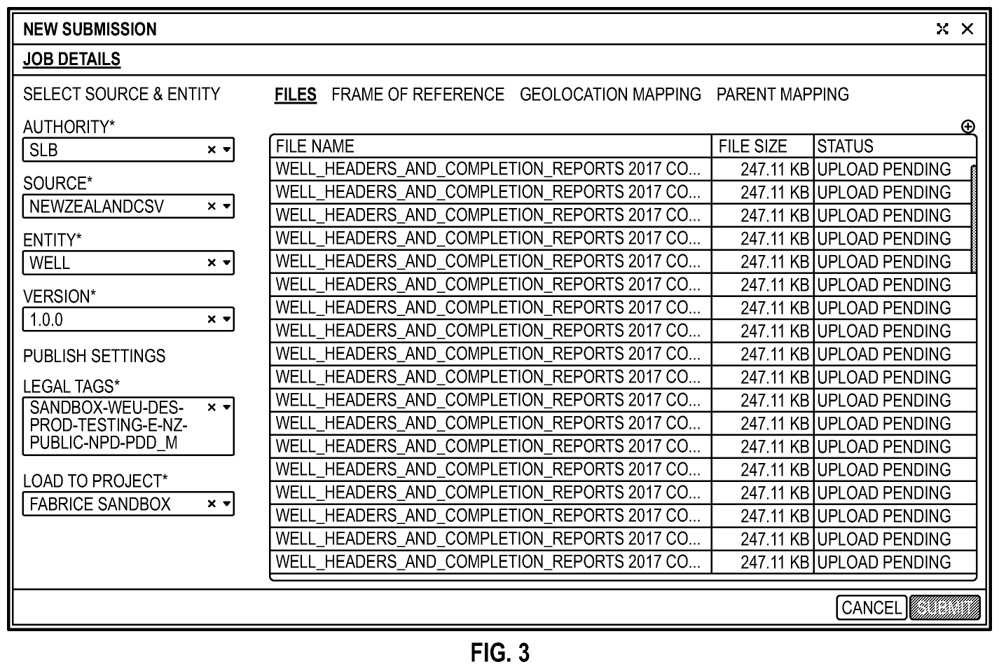

Assuming that the Kanban board is empty, a user can drag and drop data files to the Kanban board such as, for example, a CSV file or other type of file. As a result, a new submission dialogue screen, as shown in FIG. 3, may be displayed because input from a user is being requested. FIG. 3 shows the new submission dialogue screen with the “Files” tab selected such that names of the files to be uploaded may be displayed along with their current status, which in FIG. 3 is shown as “Upload Pending”. The new submission dialogue screen may request different inputs depending on a type of the files to be uploaded. For example, a “LAS” file does not need very much additional input because data is automatically read from the “LAS” file itself. For a CSV file, a data type such as, for example, well header data, as shown in FIG. 3, or another type of data may be provided. At a minimum, the new submission dialogue screen may request a legal tag and a name of a project to load regardless of the data type. As shown in FIG. 3, the user may provide a name of an authority, a source, an entity, and a version number.

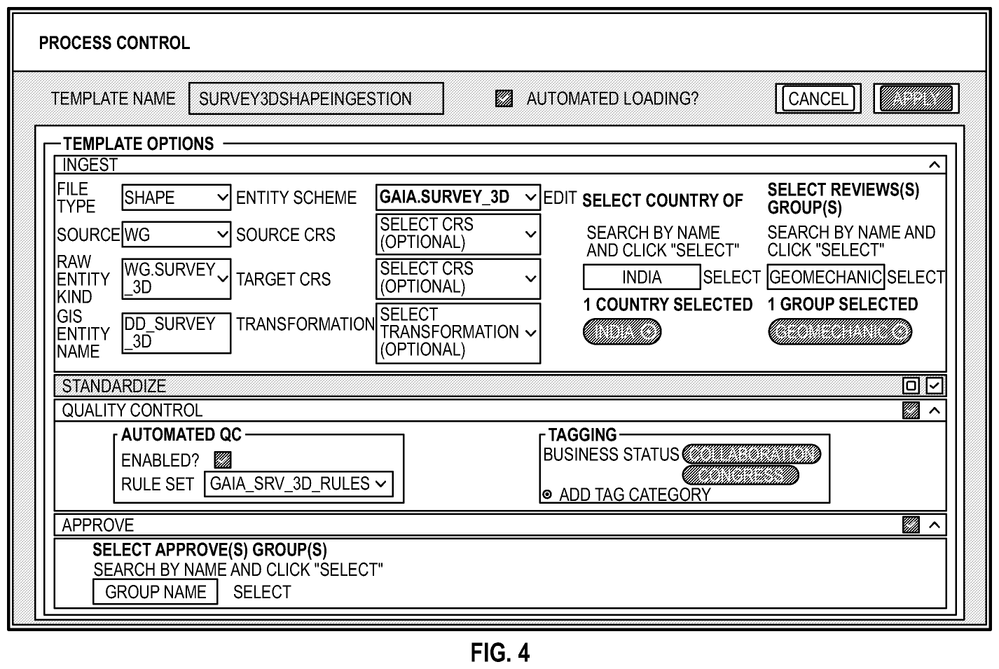

FIG. 4 shows an example process control screen. In FIG. 4, an ingest portion shows provided input for loading a “shapefile”, which may be lines or polygons on a map representing anything from borders, or a country, to a seismic surface. The process control screen may be displayed as part of a new submission dialogue when data of a new data type is to be uploaded. Before loading a file that includes a new currently unknown data type, a schema for this new data type may be previously configured. In some embodiments, when a new data type is to be uploaded, a screen for configuring a schema corresponding to the new data type may automatically be displayed.

During ingestion, file structure may be validated against the schema to ensure that it is of the correct type. Incorrect files may fail validation.

Although not shown in detail in FIG. 4, standardization may be configured for a newly created data type in order to map properties in a schema to properties of a schema for a standard such as, for example, an OSDU standard.

In FIG. 4, automated quality control is enabled in a quality control section using a rule set having a name provided by a user as input. In some embodiments, quality control may be configured as automated or as manual. If quality control is configured as manual, a data loading job may pause during quality control to wait for a human being to check the data, determine whether the data is valid, and indicate whether the data or portions of the data are approved or rejected. Depending on whether the data or portions of the data are approved or rejected, a tag may be attached to the data indicating whether the data or portions of the data are approved or rejected.

The process control screen further may request a user to provide a group name for an approval group. The approval group is a group of users who are responsible for performing manual approval.

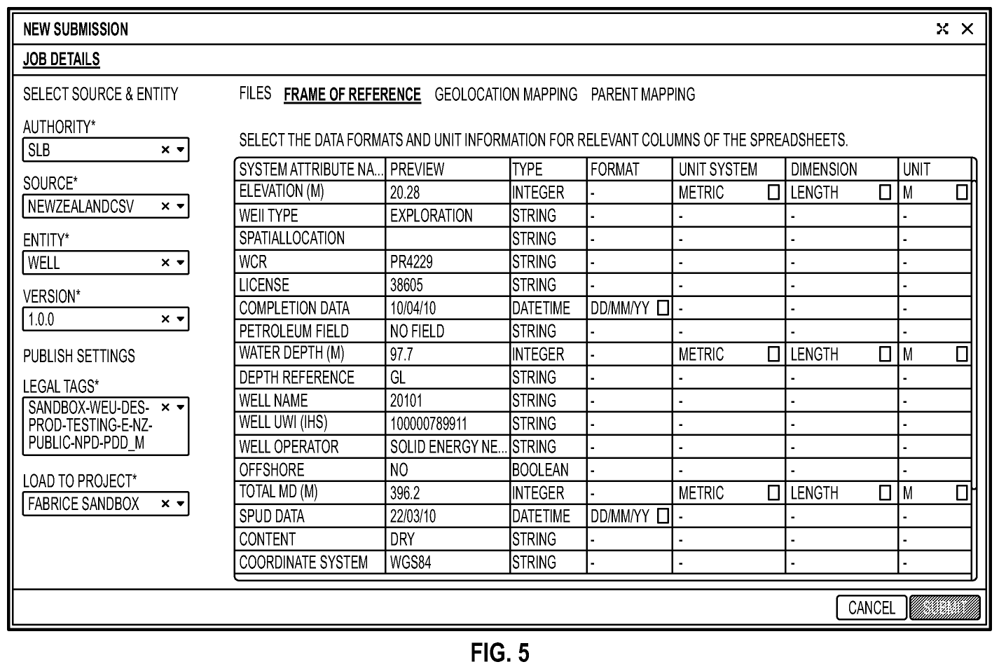

FIG. 5 illustrates the new submission dialogue screen of FIG. 3 with an optional Frame of Reference tab selected. This screen allows a user to configure a unit system for measurements such as, for example, metric or English, a date format, and a data type for values of various system attributes.

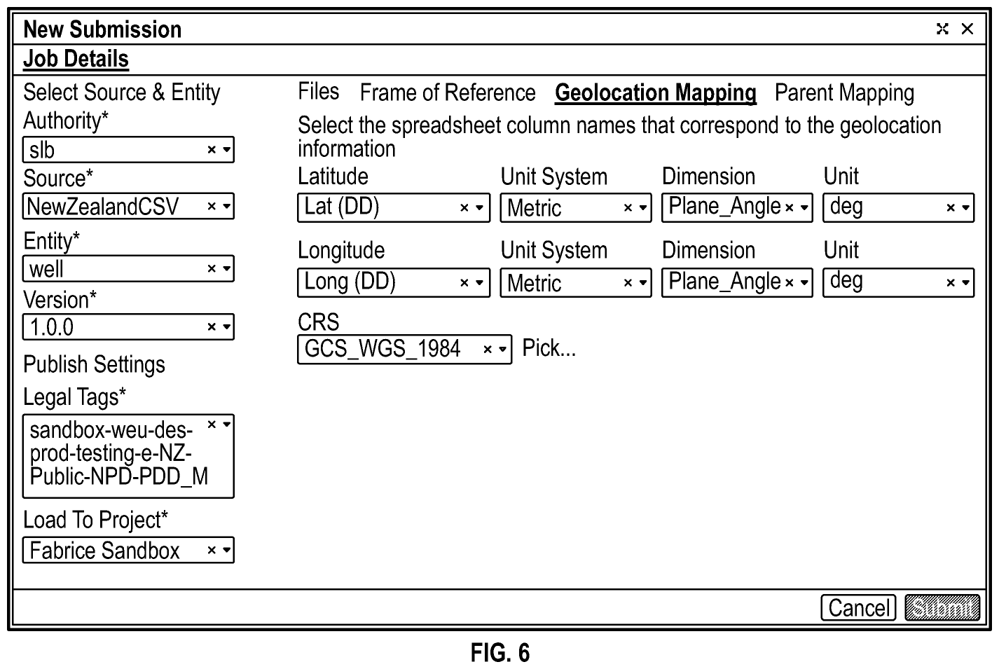

FIG. 6 shows the new submission dialogue screen with an optional geolocation mapping tab selected. This screen requests a user to provide spreadsheet column names for latitude and longitude, a coordinate reference system used, and a unit system such as, for example, metric or English.

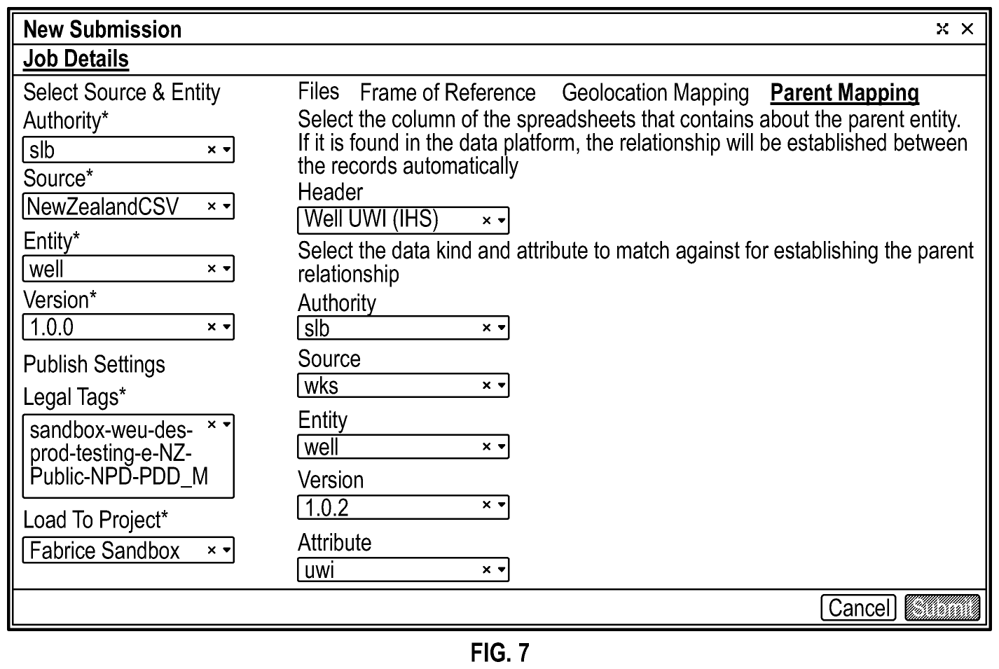

FIG. 7 illustrates the new submission screen with an optional parent mapping tab selected. This screen allows a user to automatically create relationships to existing data. In FIG. 7, a user may provide input to indicate that CSV files contain wellbore headers. In this example, a column called ParentWellID may provide information about a respective parent well associated with each child well. If a parent well is found in stored standardized data (for example, OSDU data) that has a same ID as a ParentWellID, then the found well may be marked as a parent well of the respective child well. Thus, according to the input provided via the new submission dialogue screen of FIG. 7, each row of a CSV file causes a new record to be created, and for each record created, an attempt may be made to create a relationship to an existing record of type “slb:wks:well:1.0.2” by finding a match with respect to a value of a UWI attribute. In various embodiments, after selecting “Submit”, in FIG. 7, a Kanban card will appear in an “Ingest” column of a Kanban board.

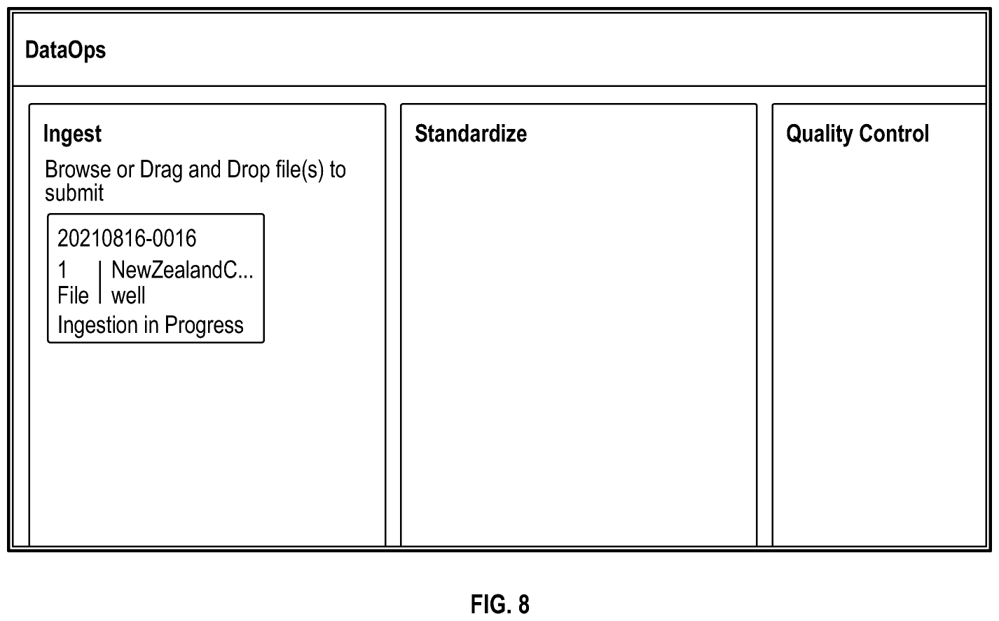

FIG. 8 illustrates an example new Kanban card appearing in the “Ingest” column of the Kanban board. As shown, the Kanban card may indicate that ingestion is in progress for one file from a source, NewZealandCSV, for an entity such as a well.

From this point on, automated processes may be performed in a background. As these processes are executed, the Kanban card will move horizontally across the Kanban board. At any time, a user may select a Kanban card using, for example, a pointing device, to open a dialogue that shows what was configured, what was processed, and if processing was completed, what records have been generated. The pointing device may include, but not be limited to, a computer mouse, a user's finger on a touchscreen, or other type of pointing device. Additional details regarding a current status may also be presented. If, at any point, user input is to be requested, horizontal movement of the Kanban card will pause and user intervention will be requested. Examples of when user input is to be requested may include when an error occurs, or when a process is to be done manually such as, for example, a manual approval process. Selecting the paused Kanban card may cause a dialogue to open requesting actions for a user to take before processing may resume.

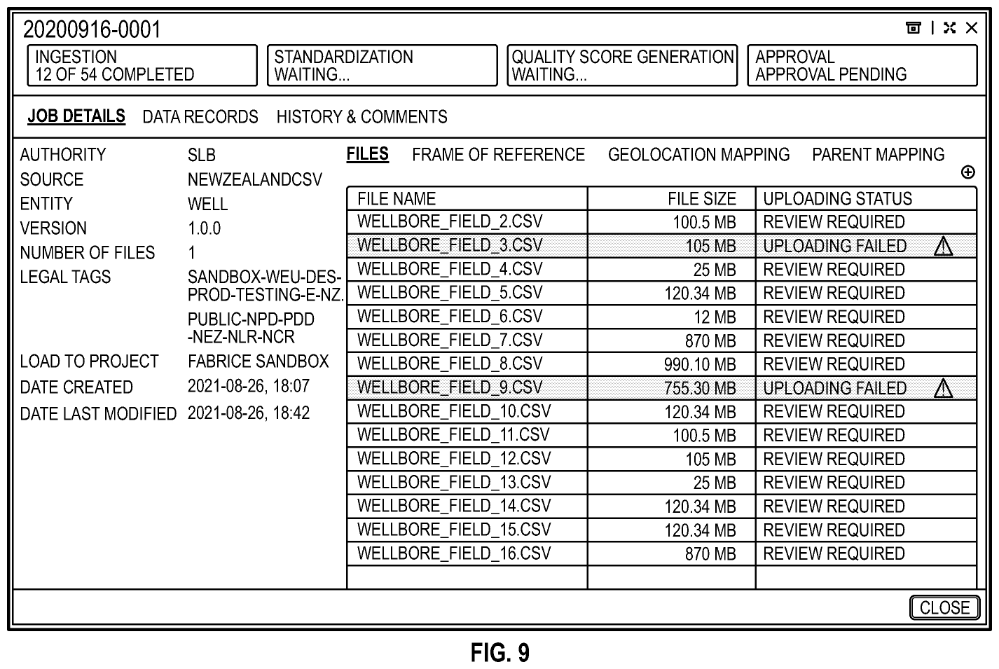

FIG. 9 shows an example screen, which may be presented, after a user selects a Kanban card while ingestion is being performed for a job represented by the Kanban card. As shown in FIG. 9, files Wellbore_Field_3.csv and Wellbore_Field_9.csv failed to upload. Remaining files had not yet been ingested.

Assuming processing continues as intended, the Kanban card will move to the standardization column, where additional records may be created of a standardized data type such as, for example, an OSDU data type.

After successfully completing standardization the Kanban card will move to the quality control column and a quality score will be calculated for each created record. Assuming, in this example, that quality control does not require any kind of manual quality control action, the Kanban card continues moving horizontally to the approve column.

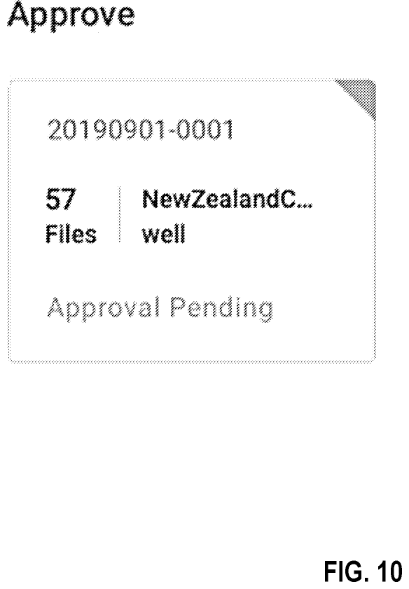

In this example, the approve column requires a manual approval. As shown in FIG. 10, the Kanban card is presented in the approve column of the Kanban card and may indicate that approval is pending via text displayed in the Kanban card. Further, a visual indication may be provided to indicate that an approval action is to be performed. In some embodiments, the visual indication may be a corner of the Kanban card having a color different from a color of a remainder of the Kanban card. In one embodiment, a top right corner of the Kanban card may have a different color. In other embodiments, a different corner of the Kanban card may have the different color.

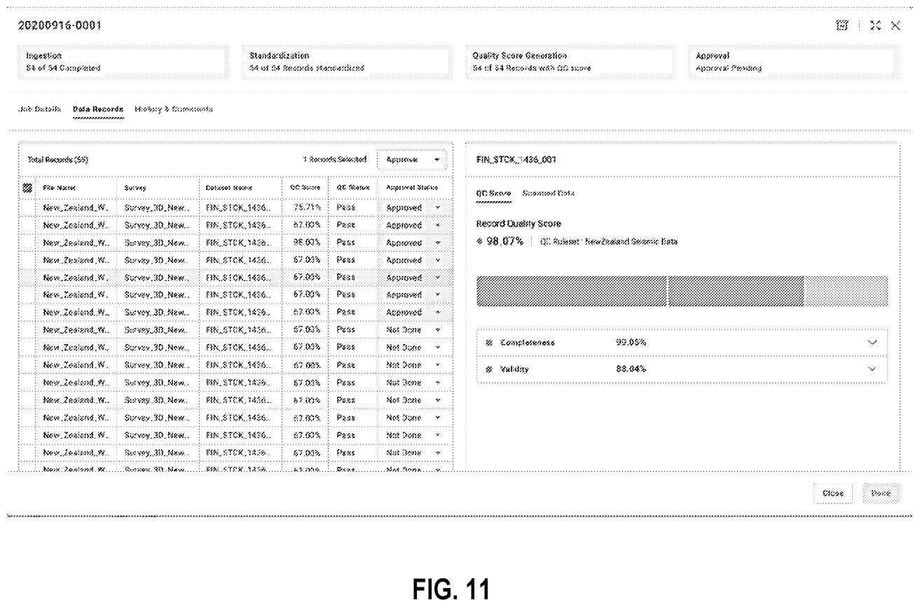

At this point, when the Kanban card is selected, a list of records may be presented along with a quality control score and a quality control status for each file. The quality control status may indicate whether the data in the file passed or failed quality control. An approval status may be displayed indicating whether the data in the file has been approved and tagged or had not yet been approved and tagged, as shown in FIG. 11. Other information may also be displayed. For example, a preview of CSV files may be presented, or for seismic data headers, tracers, as well as other information may be presented.

When the approval process is completed, the approved records may be made available to other users and the Kanban card will vanish from the Kanban board. In some embodiments, the Kanban card may be added to an archived jobs section for keeping a history of jobs.

As described herein, the Kanban board system, in accordance with aspects of the present disclosure, is flexible so as to accommodate variations in types of data and workflows and provides the framework needed to handle all common petrotechnical data types. To use the automated data loading system, described herein, the user may select files that are to be loaded to the data ecosystem.

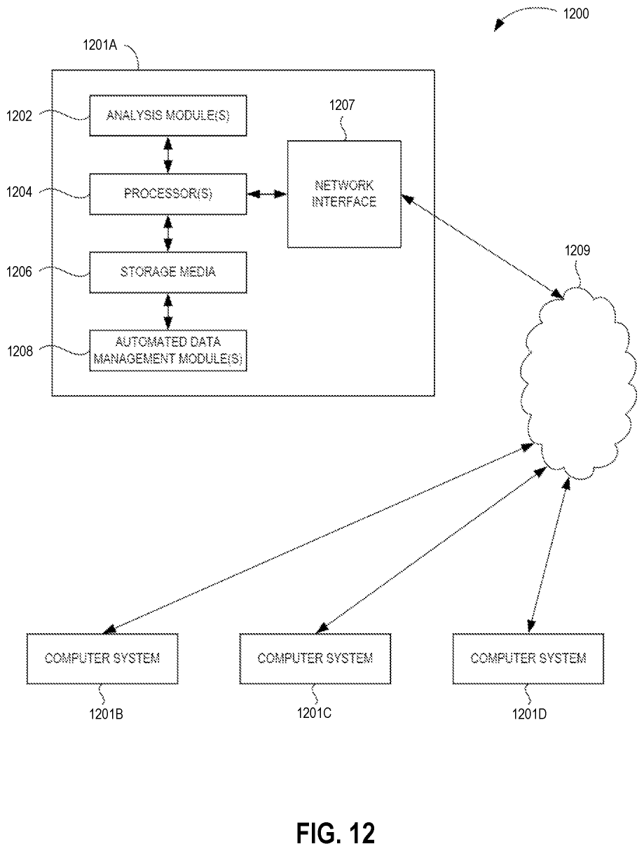

In some embodiments, the methods of the present disclosure may be executed by one or more computing systems, which may be in a cloud computing environment. FIG. 12 illustrates an example of such a computing system 1200, in accordance with some embodiments. The computing system 1200 may include a computer or computer system 1201A, which may be an individual computer system 1201A or an arrangement of distributed computer systems. The computer system 1201A includes one or more analysis modules 1202 that are configured to perform various tasks according to some embodiments, such as one or more methods disclosed herein. To perform these various tasks, the analysis module 1202 executes independently, or in coordination with, one or more processors 1204, which is (or are) connected to one or more storage media 1206. The processor(s) 1204 is (or are) also connected to a network interface 1207 to allow the computer system 1201A to communicate over a data network 1209 with one or more additional computer systems and/or computing systems, such as 1201B, 1201C, and/or 1201D (note that computer systems 1201B, 1201C and/or 1201D may or may not share the same architecture as computer system 1201A, and may be located in different physical locations, e.g., computer systems 1201A and 1201B may be located in a processing facility, while in communication with one or more computer systems such as 1201C and/or 1201D that are located in one or more data centers, and/or located in varying countries on different continents).

A processor may include a microprocessor, microcontroller, processor module or subsystem, programmable integrated circuit, programmable gate array, or another control or computing device.

The storage media 1206 may be implemented as one or more computer-readable or machine-readable storage media. Note that while in the example embodiment of FIG. 12 storage media 1206 is depicted as within computer system 1201A, in some embodiments, storage media 1206 may be distributed within and/or across multiple internal and/or external enclosures of computing system 1201A and/or additional computing systems. Storage media 1206 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1200 contains one or more automated data management module(s) 1208. In the example of computing system 1200, computer system 1201A includes the automated data management module 1208. In some embodiments, a single automated data management module 1208 may be used to perform some aspects of one or more embodiments of the methods disclosed herein. In other embodiments, a plurality of automated data management modules 1208 may be used to perform some aspects of methods herein.

It should be appreciated that computing system 1200 is merely one example of a computing system, and that computing system 1200 may have more or fewer components than shown, may combine additional components not depicted in the example embodiment of FIG. 12, and/or computing system 1200 may have a different configuration or arrangement of the components depicted in FIG. 12. The various components shown in FIG. 12 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1200, FIG. 12), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosed embodiments and various embodiments with various modifications as are suited to the particular use contemplated.

What is claimed is:

1. A uniform method for automating and tracking loading and management of a plurality of types of data into a data ecosystem, the uniform method comprising:
ingesting, by at least one computing device, data into the data ecosystem;
standardizing, by the at least one computing device, the ingested data to generate standardized data and metadata for storage and display;
quality controlling, by the at least one computing device, the standardized data to produce quality controlled standardized data;
approving, via the at least one computing device, the quality controlled standardized data; and
displaying, by the at least one computing device, progress of the ingesting, the standardizing, the quality controlling, and the approving in a Kanban board.

2. The uniform method of claim 1, wherein:
the data being ingested, standardized, quality controlled, and approved is for a plurality of jobs,
data of each of the plurality of jobs is of a respective data type, and
the respective data types of at least two of the plurality of jobs are not of the same data type.

3. The uniform method of claim 2, wherein the data is standardized according to a standard.

4. The uniform method of claim 1, wherein the ingesting of the data further comprises validating the data.

5. The uniform method of claim 1, further comprising:
automatically passing successfully processed data that has been one of successfully ingested, successfully standardized, and successfully quality reviewed to a next process, wherein:
when the data is successfully ingested, the next process is standardizing,
when the data is successfully standardized, the next process is quality control, and.
when the data is successfully quality controlled, the next process is approval.

6. The uniform method of claim 1, further comprising:
receiving, by the at least one computing device, approval of the data after a quality review of the data is completed, wherein
the receiving the approval further comprises attaching an approval tag to the approved data.

7. The uniform method of claim 1, further comprising:
receiving, by the at least one computing device, a selection of one of a plurality of cards displayed on the Kanban board; and
displaying, by the at least one computing device, detail regarding a task represented by the card in response to the receiving of the selection.

8. A computing system for automating and tracking loading and management of a plurality of types of data into a data ecosystem, the computing system comprising:
a processor; and
a memory connected with the processor, the memory including instructions for the computing system to perform operations, wherein the operations comprise:
ingesting data into the data ecosystem,
standardizing the ingested data to generate standardized data and metadata for storage and display,
quality controlling the standardized data to produce quality controlled standardized data,
approving the quality controlled standardized data, and
displaying progress of the ingesting, the standardizing, the quality controlling, and the approving in a Kanban board.

9. The computing system of claim 8, wherein:
the data being ingested, standardized, quality controlled, and approved is for a plurality of jobs,
data of each of the plurality of jobs is of a respective data type, and
the respective data types of at least two of the plurality of jobs are not of the same data type.

10. The computing system of claim 9, wherein:
the data is standardized according to only one standard, and
the operations further comprise:
receiving a selection of one of a plurality of cards displayed on the Kanban board, and
displaying detail regarding a task represented by the card in response to the receiving of the selection.

11. The computing system of claim 8, wherein the ingesting of the data further comprises validating the data.

12. The computing system of claim 8, wherein the operations further comprise:
automatically passing successfully processed data that has been one of successfully ingested, successfully standardized, and successfully quality reviewed to a next process, wherein:
when the data is successfully ingested, the next process is standardizing,
when the data is successfully standardized, the next process is quality control, and.
when the data is successfully quality controlled, the next process is approval.

13. The computing system of claim 8, wherein the operations further comprise:
receiving approval of the data after a quality review of the data is completed, wherein
the receiving the approval further comprises attaching an approval tag to the approved data.

14. The computing system of claim 8, wherein the operations further comprise:
receiving a selection of one of a plurality of cards displayed on the Kanban board; and
displaying detail regarding a task represented by the card in response to the receiving of the selection.

15. A non-transitory machine-readable medium having instructions stored thereon to configure a computing device to perform operations, wherein the operations comprise:
ingesting data into a data ecosystem,
standardizing the ingested data to generate standardized data and metadata for storage and display,
quality controlling the standardized data to produce quality controlled standardized data,
approving the quality controlled standardized data, and
displaying progress of the ingesting, the standardizing, the quality controlling, and the approving in a Kanban board, wherein:
the data being ingested, standardized, quality controlled, and approved is for a plurality of jobs,
data of each of the plurality of jobs is of a respective data type, and
the respective data types of at least two of the plurality of jobs are not of the same data type.

16. The non-transitory machine-readable medium of claim 15, wherein the data is standardized according to an Open Group Open Subsurface Data Universe standard.

17. The non-transitory machine-readable medium of claim 15, wherein the ingesting of the data further comprises validating the data.

18. The non-transitory machine-readable medium of claim 15, wherein the operations further comprise:
automatically passing successfully processed data that has been one of successfully ingested, successfully standardized, and successfully quality reviewed to a next process, wherein:
when the data is successfully ingested, the next process is standardizing,
when the data is successfully standardized, the next process is quality control, and.
when the data is successfully quality controlled, the next process is approval.

19. The non-transitory machine-readable medium of claim 15, wherein the operations further comprise:
receiving approval of the data after a quality review of the data is completed, wherein
the receiving the approval further comprises attaching an approval tag to the approved data.

20. The non-transitory machine-readable medium of claim 15, wherein the operations further comprise:
receiving a selection of one of a plurality of cards displayed on the Kanban board; and
displaying detail regarding a task represented by the card in response to the receiving of the selection.
